(19) United States
(12) Patent Application Publication
(10) Pub. No.: US 2025/0076822 A1
(43) Pub. Date: Mar. 6, 2025

(54) ELECTRONIC TIMEPIECE, INDICATION CONTROL METHOD, AND STORAGE MEDIUM

(71) Applicant: CASIO COMPUTER CO., LTD., Tokyo (JP)

(72) Inventors: Noriyuki KITTA, Tokyo (JP); Hiroyoshi OGAWA, Tokyo (JP)

(73) Assignee: CASIO COMPUTER CO., LTD., Tokyo (JP)

(21) Appl. No.: 18/819,248

(22) Filed: Aug. 29, 2024

(30) Foreign Application Priority Data
Aug. 31, 2023 (JP) 2023-140625

(51) Int. Cl. G04G 9/00; G04B 19/253; G04F 8/00

(52) U.S. Cl. CPC G04G 9/0005; G04B 19/253; G04F 8/006

(57) ABSTRACT

An electronic timepiece includes a dial, a first indicator, a second indicator, and a processor. The first indicator is provided on a region of the dial. The second indicator is provided on a region of the dial different from the region of the first indicator. The processor causes the first indicator and the second indicator to indicate first information at a predetermined timing for a predetermined period.

### REFERENCE TO RELATED APPLICATIONS

This application is based upon and claims the benefit of priority from the prior Japanese Patent Application No. 2023-140625, filed on Aug. 31, 2023, the entire disclosure of which is incorporated herein by reference in its entirety.

### TECHNICAL FIELD

The present disclosure relates to an electronic timepiece, an indication control method, and a storage medium.

### DESCRIPTION OF RELATED ART

A known timepiece, such as the one disclosed in JP 2020-098099A, is configured to indicate a remaining battery when shifting modes (e.g., when returning from a world time mode to a normal time indication mode) by pointing at the remaining battery with a mode hand.

### SUMMARY OF THE INVENTION

According to an aspect of the present disclosure, there is provided an electronic timepiece including: a dial; a first indicator provided on a region of the dial; a second indicator provided on a region of the dial different from the region of the first indicator; and a processor that causes the first indicator and the second indicator to indicate first information at a predetermined timing for a predetermined period.

### BRIEF DESCRIPTION OF THE DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a block diagram showing a schematic functional configuration of an electronic timepiece according to an embodiment;

FIG. 2 is an example of the external appearance of the electronic timepiece in FIG. 1;

FIG. 3 is an enlarged view of an atmospheric pressure indicator in FIG. 2;

FIG. 4 shows the flowchart of a mode shift process to be executed by the CPU in FIG. 1;

FIG. 5A shows an example of indication by the electronic timepiece in a BT mode;

FIG. 5B shows another example of indication by the electronic timepiece in the BT mode;

FIG. 5C shows another example of indication by the electronic timepiece in the BT mode;

FIG. 6A shows an example of indication by the electronic timepiece within a predetermined period immediately after shifting to an atmospheric pressure mode;

FIG. 6B shows an example of indication by the electronic timepiece indicating the result of measuring the atmospheric pressure in the atmospheric pressure mode;

FIG. 7A shows an example of indication by the electronic timepiece within a predetermined period immediately after shifting to a stopwatch mode;

FIG. 7B shows an example of indication by the electronic timepiece in the stopwatch mode;

FIG. 8A shows an example of indication by the electronic timepiece when the remaining battery level is “High”, the indication being shown for a predetermined period after returning to the BT mode;

FIG. 8B shows an example of indication by the electronic timepiece when the remaining battery level is “Middle”, the indication being shown for a predetermined period after returning to the BT mode;

FIG. 9A shows an example of indication by the electronic timepiece when the remaining battery level is “Low”, the indication being shown for a predetermined period after returning to the BT mode; and

FIG. 9B shows indication of a warning of a battery shortage that is shown after the indication of FIG. 9A.

### DETAILED DESCRIPTION

Hereinafter, an embodiment of the present invention is described with reference to the figures. The embodiment described below includes various limitations technically preferable for implementing the present invention. The technical scope of the present disclosure is not limited to the following embodiment or illustrated examples.

### Configuration of Electronic Timepiece 1

A configuration of an electronic timepiece 1 in this embodiment is described.

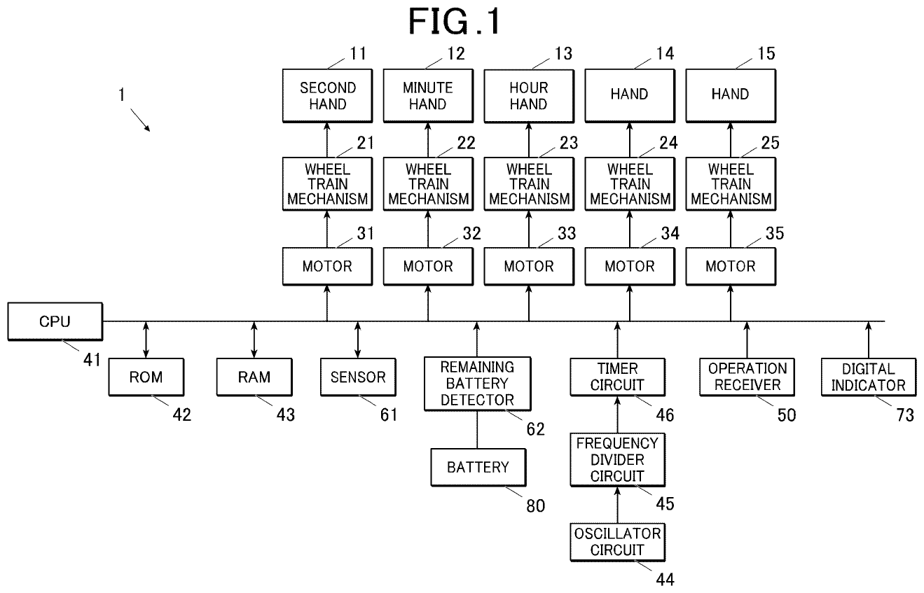

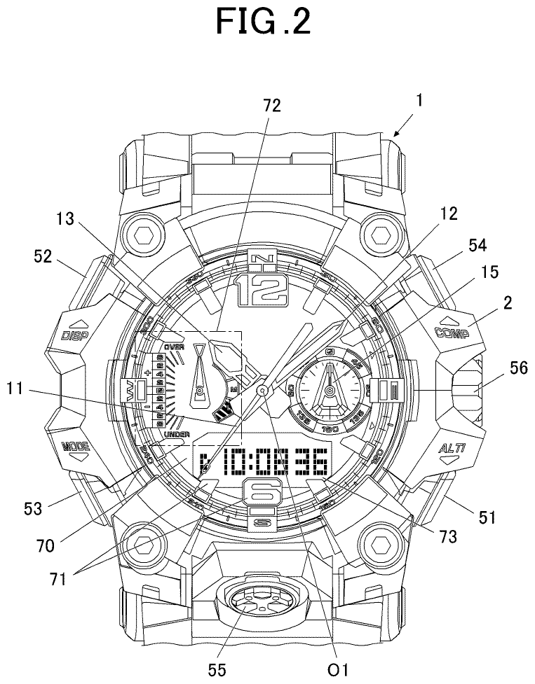

FIG. 1 is a block diagram showing a schematic functional configuration of the electronic timepiece 1. FIG. 2 shows the external appearance of the electronic timepiece 1. As shown in FIG. 2, the electronic timepiece 1 is a wristwatch, for example.

As shown in FIG. 1, the electronic timepiece 1 includes a central processing unit (CPU) 41, a read only memory (ROM) 42, a random access memory (RAM) 43, an oscillator circuit 44, a frequency divider circuit 45, and timer circuit 46. The electronic timepiece 1 further includes an operation receiver 50, motors 31 to 35, wheel train mechanisms 21 to 25, a second hand 11, a minute hand 12, an hour hand 13, a hand 14, a hand 15, a sensor 61, a remaining battery detector 62, a digital indicator 73, and a battery 80.

The CPU 41 (processor) loads programs from the ROM 42 into the RAM 43 and executes the programs to control operations of the electronic timepiece 1. Thus, the CPU 41 provides a time indication function and other functions and switches between these functions.

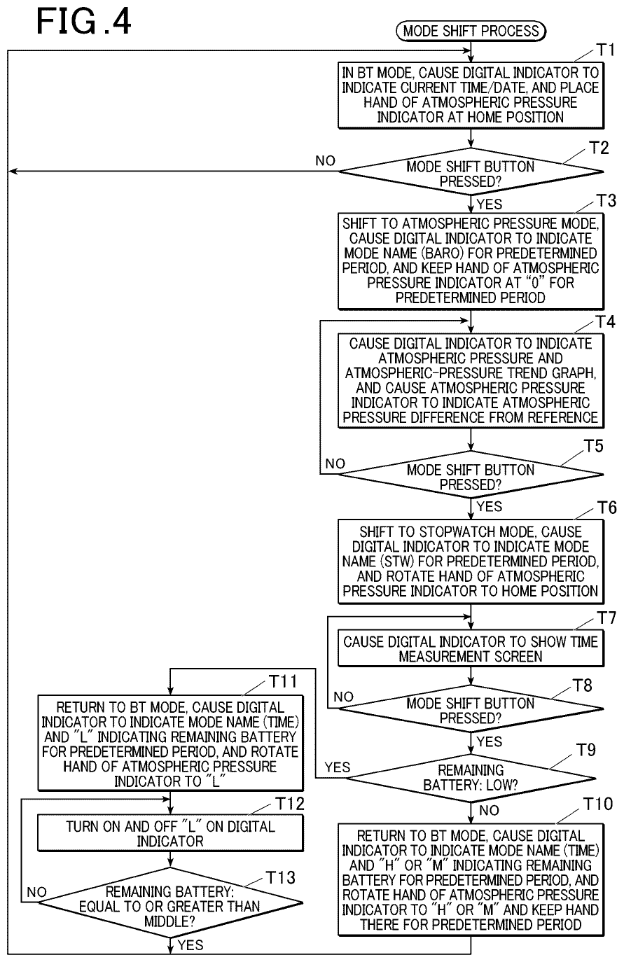

For example, the CPU 41 executes a mode shift process (see FIG. 4) in accordance with a program loaded from the ROM 42. The mode shift process is described later.

The ROM 42 is a nonvolatile memory. The ROM 42 stores programs and various kinds of data for the CPU 41 to control operations of the electronic timepiece 1, such as the time display function. The ROM 42 is a non-transitory computer-readable storage medium that stores programs executable by the CPU 41 that serves as the processor of the computer of the electronic timepiece 1.

The RAM 43 is a volatile or a nonvolatile memory. The RAM 43 temporarily stores a program stored in the ROM 42 and stores temporary data needed for controlling operations of the electronic timepiece 1.

The oscillator circuit 44 generates predetermined frequency signals by using a crystal oscillator, for example, and outputs the signals to the frequency divider circuit 45.

The frequency divider circuit 45 divides the frequency signals and outputs the divided signals to the timer circuit 46 and the CPU 41. The timer circuit 46 counts the signals input by the frequency divider circuit 45 and adds the count to an initial value to calculate the current date and time. The timer circuit 46 outputs the result of the calculation to the CPU 41.

The operation receiver 50 includes an S1 button 51, an S2 button 52, an S3 button 53, an S4 button 54, and an SA button 55. The operation receiver 50 receives pressing operations by the user and outputs signals corresponding to the pressing operations to the CPU 41. The operation receiver 50 also includes a crown 56.

The motors 31 to 35 rotate under the commands of the CPU 41.

The motor 31 rotates the second hand 11 via the wheel train mechanism 21 constituted of a train of wheels. The motor 32 rotates the minute hand 12 via the wheel train mechanism 22. The motor 33 rotates the hour hand 13 via the wheel train mechanism 23. The second hand 11, the minute hand 12, and the hour hand 13 correspond to second pointers in the present disclosure.

The motor 34 rotates the hand 14 via the wheel train mechanism 24. The hand 14 corresponds to a first pointer in the present disclosure. The motor 35 rotates the hand 15 via the wheel train mechanism 25.

It is preferable that a luminous paint be applied to the second hand 11, the minute hand 12, the hour hand 13, the hand 14, and the hand 15.

The sensor 61 is an atmospheric pressure sensor that measures an atmospheric pressure. The sensor 61 outputs the measurement result to the CPU 41.

In an atmospheric pressure mode, the CPU 41 causes the sensor 61 to measure an atmospheric pressure in predetermined time intervals (for example, 2-minute intervals). The atmospheric pressure mode is a mode of measuring and indicating an atmospheric pressure. The CPU 41 also causes the sensor 61 to automatically measure an atmospheric pressure in predetermined time intervals (for example, 2-hour intervals) and store the measurement result in a not-illustrated atmospheric pressure storage area of the RAM 43. In the atmospheric pressure storage area, a predetermined number (e.g., ten) of automatic measurement results are stored in a first-in, first-out (FILO) manner.

In this embodiment, the sensor 61 is an atmospheric pressure sensor as an example. The sensor 61 may be other sensors, such as an orientation sensor, a temperature sensor, or a humidity sensor.

The remaining battery detector 62 detects the remaining battery of the battery 80 and outputs the detection result to the CPU 41.

The battery 80 supplies electronic power to the components of the electronic timepiece 1. The battery 80 is, for example, a secondary battery that charges with a not-illustrated solar battery stored under the light-transmitting dial 70.

The digital indicator 73 is constituted of a display screen, such as a liquid crystal screen or an organic electro-luminescence screen. The digital indicator 73 displays various contents under the commands of the CPU 41.

The dial 70 is mounted in the casing 2 of the electronic timepiece 1. The top surface of the dial 70 is covered with a not-illustrated transparent windshield glass. As shown in FIG. 2, the dial 70 in this embodiment is round and has hour markers 71 (indexes) and scale marks along the peripheral direction of the dial 70. At the center of the dial 70, the second hand 11, the minute hand 12, the hour hand 13, and a shaft O1 are provided. The shaft O1 is for rotating the second hand 11, the minute hand 12, and the hour hand 13. The second hand 11, the minute hand 12, and the hour hand 13 (second pointers) rotate on the shaft O1 and point at appropriate hour markers 71 or scale marks to indicate time.

On a region of the dial 70, an atmospheric pressure indicator 72 (first indicator) is provided. On a region of the dial 70 different from the region of the atmospheric pressure indicator 72, a digital indicator 73 (second indicator) is provided (mounted).

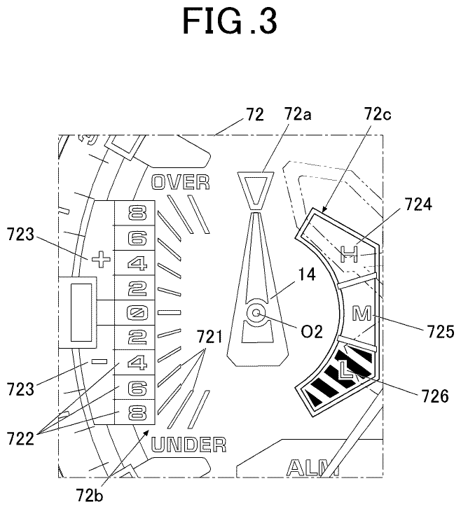

FIG. 3 is an enlarged view of the atmospheric pressure indicator 72 enclosed by the alternate-long-and-short-dash line in FIG. 2.

As shown in FIG. 3, the atmospheric pressure indicator 72 includes the hand 14, a home position 72a, an atmospheric pressure indication area 72b (second area), and a remaining battery indication area 72c (first area).

The atmospheric pressure indication area 72b is for the hand 14 to point at an atmospheric pressure (second information) in the atmospheric pressure mode.

The atmospheric pressure indication area 72b includes scale marks 721 (second scale marks), numbers 722 corresponding to the scale marks 721, and signs 723.

The scale marks 721 are for the hand 14 to point at an atmospheric pressure. In this embodiment, the atmospheric pressure indicator 72 indicates an atmospheric pressure difference between the current atmospheric pressure and a reference atmospheric pressure that has been automatically measured immediately before the current measurement and that is set as the reference (zero). The atmospheric pressure indicator 72 has thirteen scale marks 721 corresponding to 0 as the midpoint (base scale mark), +2, +4, +6, +8, +10, OVER (greater than 10), −2, −4, −6, −8, −10, and UNDER (less than 10).

The numbers 722 correspond to the scale marks 721. The numbers 722 include words, such as “OVER” and “UNDER”, as shown in FIG. 3.

The signs 723 are for indicating whether the numbers 722 are positive or negative.

The interval between the scale marks 721 can be determined by a user as desired, by manipulating the operation receiver 50 or via a smartphone, for example. For example, the interval between the scale marks 721 may be set to 2 [hPa] so that one increment/decrement of the scale marks 721 corresponds to the change of the atmospheric pressure difference by 2 [hPa]. The interval between the scale marks 721 may be set to 100 [hPa] so that one increment/decrement of the scale marks 721 corresponds to the change of the atmospheric pressure difference by 100 [hPa].

The remaining battery indication area 72c includes scale marks (first scale marks) for the hand 14 to point at the remaining battery (the level of the remaining battery, first information). The remaining battery indication area 72c includes, as first scale marks, an H scale mark 724 corresponding to “High”, an M scale mark 725 corresponding to “Middle”, and an L scale mark 726 corresponding to “Low”.

On the dial 70, the scale marks 721 of the atmospheric pressure indication area 72b are arranged outside the scale marks of the remaining battery indication area 72c (the H scale mark 724, the M scale mark 725, and the L scale mark 726). That is, the scale marks 721 are farther from the center of the dial 70 than the H scale mark 724, the M scale mark 725, and the L scale mark 726. Such arrangements can prevent decrease of viewability of the atmospheric pressure difference, which is indicated longer than the remaining battery, by the hour hand 13 and other hands.

The hand 14 is normally at the home position 72a. When the electronic timepiece 1 shifts to the atmospheric pressure mode, the hand 14 is rotated on the shaft O2 (rotating shaft) to point at one of the scale marks 721, based on the current atmospheric pressure. Thus, the hand 14 indicates the atmospheric pressure. Further, when the electronic timepiece 1 returns to the BT mode (base time mode, time indication mode), the hand 14 is rotated on the shaft O2 (rotating shaft) to point at one of the H scale mark 724 region, the M scale mark 725 region, and the L scale mark 726 region, based on the remaining battery of the battery 80. Thus, the hand 14 indicates the remaining battery.

The digital indicator 73 indicates various contents in response to the mode shift of the electronic timepiece 1. Details are described later.

### Indication operation of Electronic timepiece 1

Next, the indication operation of the electronic timepiece 1 is described.

The electronic timepiece 1 has the BT mode (first mode) for indicating the current time and one or more other operation modes for providing g a function other than indicating the current time. In this embodiment, the electronic timepiece 1 has the atmospheric pressure mode for measuring and indicating the atmospheric pressure and the stopwatch mode for providing the stopwatch function, for example. The electronic timepiece 1 may have other operation modes, such as a compass mode, a world time mode, and a thermometer mode. The second hand 11, the minute hand 12, and the hour hand 13 are controlled to indicate the current time in operation modes other than the BT mode, as well as in the BT mode.

The BT mode is the basic operation mode of the electronic timepiece 1. The user can shift (switch) the operation mode of the electronic timepiece 1 from one mode to another by pressing the S3 button 53 (mode shift key). In this embodiment, every time the S3 button 53 is pressed, the electronic timepiece 1 shifts from the BT mode to the atmospheric pressure mode, from the atmospheric pressure mode to the stopwatch mode, and from the stopwatch mode to the BT mode.

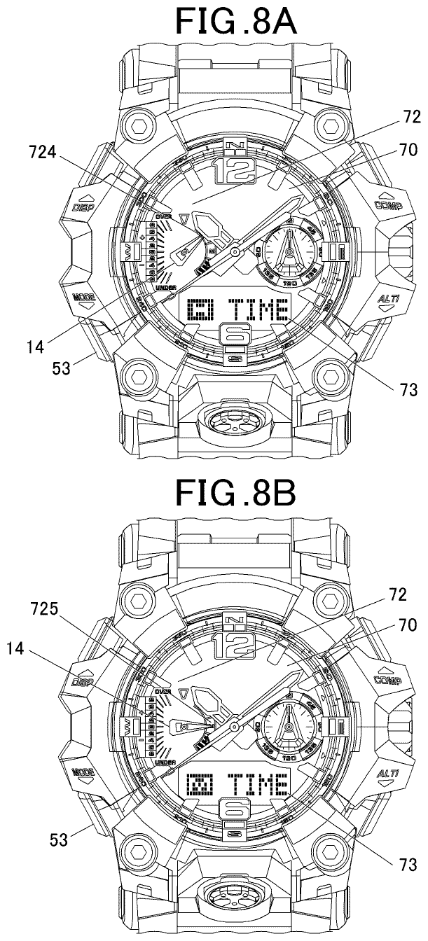

As described above, according to the electronic timepiece 1 in this embodiment, the atmospheric pressure indicator 72 indicates the remaining battery for a predetermined period at the timing of returning to (switching to) the BT mode from the other mode. Since the hand 14 for indicating the remaining battery is positioned behind the second hand 11, the minute hand 12, and the hour hand 13 that indicate time in the direction in which the electronic timepiece 1 is viewed (viewing direction), the user cannot perceive the indicated remaining battery when the hand 14 is overlapped by the second hand 11, the minute hand 12, or the hour hand 13 (see FIG. 8A). Further, if the remaining battery is indicated for only a short period, the user is more likely to overlook the indicated remaining battery. Similarly, if the remaining battery is indicated only on the digital indicator 73 and the remaining battery indicated on the digital indicator 73 is overlapped by the second hand 11, the minute hand 12, or the hour hand 13, the user cannot perceive the indicated remaining battery. Further, if the remaining battery is indicated only on the digital indicator 73, the remaining battery is perceivable in a bright space but is less perceivable in a dark space. If a luminous paint is applied to the hand 14, the hand 14 is more perceivable than the digital indicator 73, as long as the hand 14 is not overlapped by the other hands. According to the electronic timepiece 1, the CPU 41 executes the mode shift process in FIG. 4. In the mode shift process, the remaining battery is indicated by both of the atmospheric pressure indicator 72 and the digital indicator 73 when the electronic timepiece 1 returns to the BT mode from the other operation mode. Thus, the electronic timepiece 1 has an increased perceivability of the remaining battery.

In this embodiment, when the electronic timepiece 1 shifts to an operation mode other than the BT mode, the atmospheric pressure indicator 72 does not indicate the remaining battery. It is assumed that the user switches the mode to an operation mode other than the BT mode because the user intends to use the function of the operation mode. Since the atmospheric pressure indicator 72 needs to move the hand 14 to indicate the remaining battery, it would take a while before the function of the operation mode becomes available. On the other hand, the timing of returning to the BT mode is the timing that the user has finished using the function of the other operation mode. Therefore, at the timing of returning to the BT mode, the atmospheric pressure indicator 72 can indicate the atmospheric pressure without disturbing the user.

FIG. 4 shows the flowchart of the mode shift process to be executed by the CPU 41. The mode shift process is executed by the CPU 41 in cooperation with the program stored in the ROM 42. The mode shift process is executed in accordance with the manipulation of the S3 button 53 as the mode shift button when the electronic timepiece 1 is operating.

Firstly, the CPU 41 performs indication in the BT mode. Specifically, the CPU 41 controls the motors 31 to 33 based on the current time (date and time) output by the timer circuit 46 and rotates the second hand 11, the minute hand 12, and the hour hand 13 to indicate the current time. The CPU 41 also causes the digital indicator 73 to indicate the current time or the date, based on the current time (date and time) output by the timer circuit 46. The CPU 41 also causes the motor 34 to rotate the hand 14 of the atmospheric pressure indicator 72 to the home position 72a (Step T1).

The second hand 11, the minute hand 12, and the hour hand 13 keep indicating the current time while the electronic timepiece 1 is operating.

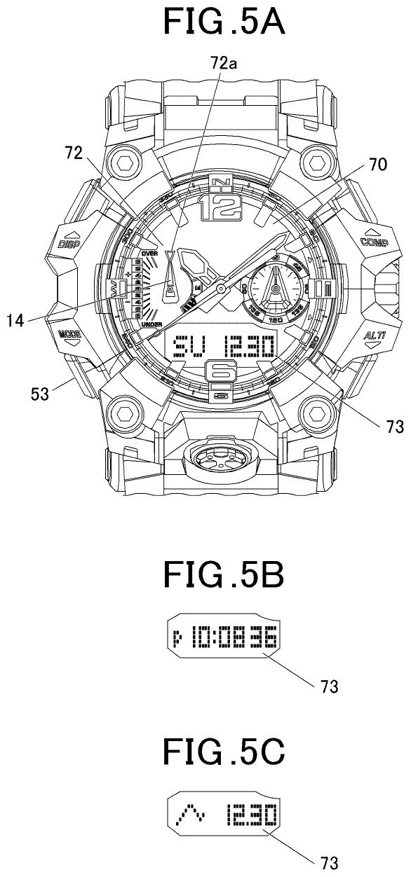

FIG. 5A shows an example of indication by the electronic timepiece 1 in the BT mode.

As shown in FIG. 5A, in the BT mode, the digital indicator 73 indicates the current time or the date. In the atmospheric pressure indicator 72, the hand 14 is set to the home position 72a. FIG. 5A shows the digital indicator 73 indicating the day (SU: Sunday) and the date (12.30) as an example. In the BT mode, the digital indicator 73 can indicate the current time as shown in FIG. 5B or the atmospheric-pressure trend graph and the date as shown in FIG. 5C, in accordance with the setting by the user. In FIG. 5B, “p” shown on the digital indicator 73 represents “PM” (afternoon). The atmospheric-pressure trend graph shows the automatic measurement result by the sensor 61 stored in the atmospheric pressure storage area.

The CPU 41 determines whether the S3 button 53, which is the mode shift button, is pressed or not (Step T2).

When determining that the S3 button 53 is not pressed (Step T2: NO), the CPU 41 returns to Step T1 and repeats Steps T1 and T2.

When determining that the S3 button 53 is pressed (Step T2: YES), the CPU 41 shifts to the atmospheric pressure mode, wherein the CPU 41 causes the digital indicator 73 to indicate the mode name (BARO) for a predetermined period (e.g., one second), controls the motor 34 to rotate the hand 14 to the position of the scale mark 721 corresponding to “0” of the numbers 722 in the atmospheric pressure indication area 72b, and keeps the hand 14 at the scale mark 721 corresponding to “0” for a predetermined period (Step T3).

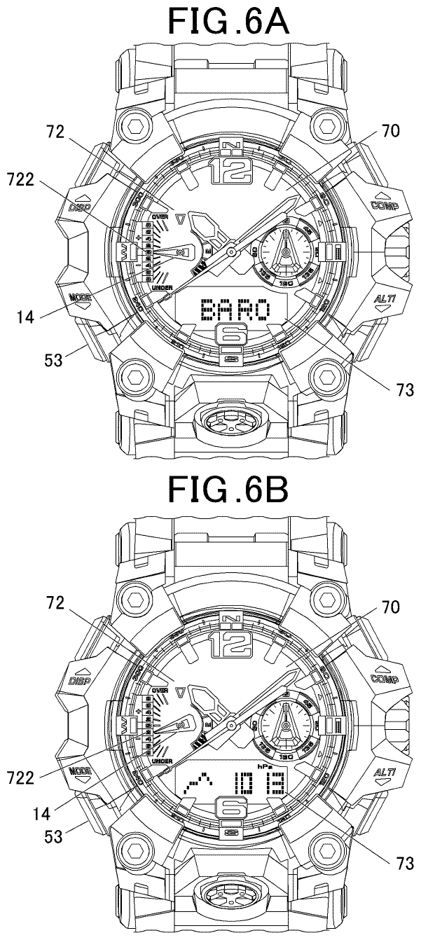

FIG. 6A shows an example of indication by the electronic timepiece 1 within a predetermined period immediately after the electronic timepiece 1 shifts to the atmospheric pressure mode.

As shown in FIG. 6A, immediately after shifting to the atmospheric pressure mode, the digital indicator 73 indicates the mode name (BARO) of the atmospheric pressure mode for a predetermined period. Thus, the user can recognize that the electronic timepiece 1 has shifted to the atmospheric pressure mode. In the atmospheric pressure indicator 72, the hand 14 is kept at the position of the scale mark 721 corresponding to “0” of the number 722 for a predetermined period.

Next, the CPU 41 obtains the measurement result by the sensor 61 and causes the atmospheric pressure indicator 72 and the digital indicator 73 to indicate the atmospheric pressure (Step T4).

In Step T4, the CPU 41 obtains the measurement result by the sensor 61 and calculates the atmospheric pressure difference between the obtained measurement result and the reference. Here, the reference is the atmospheric pressure value obtained in the latest automatic measurement. Based on the calculated atmospheric pressure difference, the CPU 41 controls the motor 34 to rotate the hand 14 to the position of the scale mark 721 corresponding to the calculated atmospheric pressure difference. Thus, the atmospheric pressure difference is indicated. The CPU 41 also causes the digital indicator 73 to indicate the measurement result (the current atmospheric pressure value) and the atmospheric-pressure trend graph.

FIG. 6B shows an example of indication by the electronic timepiece 1 indicating the result of measuring the atmospheric pressure in the atmospheric pressure mode.

As shown in FIG. 6B, in the atmospheric pressure mode, the measurement result [hPa] by the sensor 61 is shown on the right part of the digital indicator 73. In FIG. 6B, the current atmospheric pressure value is 1013 (hPa). Further, the atmospheric-pressure trend graph is shown on the left part of the digital indicator 73. In the atmospheric pressure indicator 72, the hand 14 points at the scale mark 721 of the number 722 corresponding to the atmospheric pressure difference. Thus, the atmospheric pressure indicator 72 indicates the atmospheric pressure difference.

Next, the CPU 41 determines whether the S3 button 53 is pressed or not (Step T5).

When determining that the S3 button 53 is not pressed (Step T5: NO), the CPU 41 returns to Step T4 and repeats Steps T4 and T5.

When determining that the S3 button 53 is pressed (Step T5: YES), the CPU 41 shifts to the stopwatch mode, wherein the CPU 41 causes the digital indicator 73 to indicate the mode name (STW) for a predetermined period (e.g., one second) and controls the motor 34 to rotate the hand 14 to the home position 72a (Step T6).

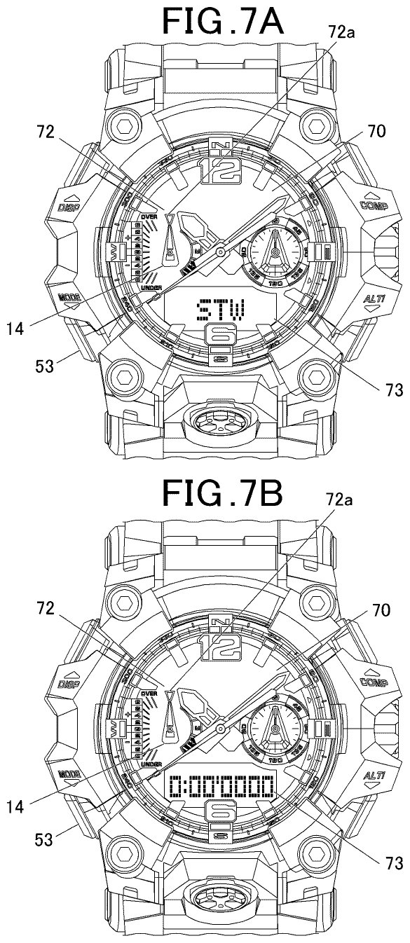

FIG. 7A shows an example of indication by the electronic timepiece 1 within a predetermined period immediately after shifting to the stopwatch mode.

As shown in FIG. 7A, immediately after shifting to the stopwatch mode, the digital indicator 73 indicates the mode name (STW) of the stopwatch mode for a predetermined period. Thus, the user can recognize that the electronic timepiece 1 has shifted to the stopwatch mode. In the atmospheric pressure indicator 72, the hand 14 is kept at the home position 72a for a predetermined period.

Next, the CPU 41 causes the digital indicator 73 to show the time measurement screen (Step T7).

FIG. 7B shows an example of indication by the electronic timepiece 1 in the stopwatch mode.

As shown in FIG. 7B, in the stopwatch mode, the digital indicator 73 shows the time measurement screen. FIG. 7B shows the state where the measurement time is reset.

When the S1 button 51 is pressed in the stopwatch mode, the CPU 41 starts measuring the amount of time and counts up the measurement time in the time measurement screen, for example. When the S1 button 51 is pressed again, the CPU 41 ends measuring the amount of time and shows the measurement result on the time measurement screen.

The CPU 41 determines whether the S3 button 53 is pressed or not (Step T8).

When determining that the S3 button 53 is not pressed (Step T8: NO), the CPU 41 returns to Step T7 and repeats Steps T7 and T8.

When determining that the S3 button 53 is pressed (Step T8: YES), the CPU 41 obtains the remaining battery (%) of the battery 80 from the remaining battery detector 62 and determines whether the level of the remaining battery is “Low” or not (Step T9).

The CPU 41 determines that the remaining battery is “Low” when the remaining battery satisfies 0≤remaining battery<n1, determines that the remaining battery is “Middle” when the remaining battery satisfies n1≤remaining battery<n2, and determines that the remaining battery is “High” when the remaining battery satisfies n2≤remaining battery. Here, n1 to n3 are positive numbers and satisfy 0≤n1<n2≤100.

When determining that the remaining battery is not “Low” (Step T9: NO), that is, determining that the remaining battery is “High” or “Middle”, the CPU 41 returns to the BT mode, wherein the CPU 41 causes the digital indicator 73 to indicate the mode name (TIME) of the BT mode and the remaining battery for a predetermined period (e.g., one second) (Step T10). The CPU 41 also controls the motor 34 to rotate the hand 14 to the position of the H scale mark 724 or the M scale mark 725 and keeps the hand 14 at the position of the H scale mark 724 or the M scale mark 725 for a predetermined period (e.g., one second) (Step T10). The CPU 41 then returns to Step T1.

In this embodiment, when pointing at one of the H scale mark 724, the M scale mark 725, and the L scale mark 726, the hand 14 points at the central part of the region of the scale mark. The position that the hand 14 points at may be changed depending on the remaining battery level.

In Step T10, in a case where the remaining battery is indicated for one second as an example, the hand 14 is moved from the home position 72a to the H scale mark 724 or the M scale mark 725, keeps pointing at the H scale mark 724 or the M scale mark 725 for one second, and returns to the home position 72a. In a case where the hand 14 points at the H scale mark 724, the time during which the atmospheric pressure indicator 72 indicates the remaining battery somewhat overlaps with the time during which the digital indicator 73 indicates the remaining battery. On the other hand, in a case where the hand 14 points at the M scale mark 725, the time during which the atmospheric pressure indicator 72 indicates the remaining battery does not overlap with the time during which the digital indicator 73 indicates the remaining battery. That is, the hand 14 arrives at the M scale mark 725 after the indication of the digital indicator 73 shifts to the indication of the BT mode.

FIG. 8A shows an example of indication by the electronic timepiece 1 within a predetermined period immediately after returning to the BT mode when the remaining battery is high.

As shown in FIG. 8A, immediately after the return to the BT mode, the mode name (TIME) representing the BT mode is shown on the right part of the digital indicator 73 for a predetermined period. This allows the user to recognize that the electronic timepiece 1 is back to the BT mode. On the left part of the digital indicator 73, the letter “H” indicating the high remaining battery is shown (highlighted) in a color reverse to the color of the mode name “TIME”. That is, the letter (character) indicating the remaining battery is shown in highlight in a manner different from the other letters (characters) indicating the other information. In the atmospheric pressure indicator 72, the hand 14 is moved to point at the H scale mark 724 of the remaining battery indication area 72c. Thus, the atmospheric pressure indicator 72 indicates that the remaining battery is “High” for a predetermined period.

FIG. 8B shows an example of indication by the electronic timepiece 1 within a predetermined period immediately after returning to the BT mode when the remaining battery level is “Middle”.

As shown in FIG. 8B, immediately after the return to the BT mode, the mode name (TIME) indicating the BT mode is shown on the right part of the digital indicator 73 for a predetermined period. This allows the user to recognize that the electronic timepiece 1 is back to the BT mode. On the left part of the digital indicator 73, the letter “M” indicating the middle remaining battery is shown in a color reverse to the color of the mode name “TIME”. That is, the letter (character) indicating the remaining battery is shown in highlight in a manner different from the other letters (characters) indicating the other information. In the atmospheric pressure indicator 72, the hand 14 is moved to point at the M scale mark 725 of the remaining battery indication area 72c. Thus, the atmospheric pressure indicator 72 indicates that the remaining battery is “Middle” for a predetermined period.

As shown in FIG. 8A and FIG. 8B, the remaining battery level is indicated for a predetermined period by both of the atmospheric pressure indicator 72 and the digital indicator 73 when the electronic timepiece 1 returns to the BT mode. This increases viewability of the remaining battery, which is indicated for only a short period, and prevents the user from overlooking the remaining battery. For example, if the hand 14 of the atmospheric pressure indicator 72 is overlapped by the second hand 11, the minute hand 12, or the hour hand 13, the user cannot perceive which scale mark the hand 14 is pointing at in the remaining battery indication area 72c. Since the digital indicator 73 also indicates the remaining battery, the user can perceive the remaining battery. For another example, if the remaining battery indicated on the digital indicator 73 is overlapped by the second hand 11, the minute hand 12, or the hour hand 13, the user cannot perceive the remaining battery on the digital indicator 73. Since the atmospheric pressure indicator 72 also indicates the remaining battery, the user can perceive the remaining battery. Further, even when the digital indicator 73 is difficult to see in a dark place, the user can perceive the remaining battery on the atmospheric pressure indicator 72.

In Step T9, when determining that the remaining battery is “Low” (Step T9: YES), the CPU 41 returns to the BT mode, wherein the CPU 41 causes the digital indicator 73 to indicate the mode name (TIME) of the BT mode and the remaining battery for a predetermined period (e.g., one second) (Step T11). The CPU 41 also controls the motor 34 to rotate the hand 14 to the position of the L scale mark 726 and keep the hand 14 at the position of the L scale mark 726 for a predetermined period (Step T11).

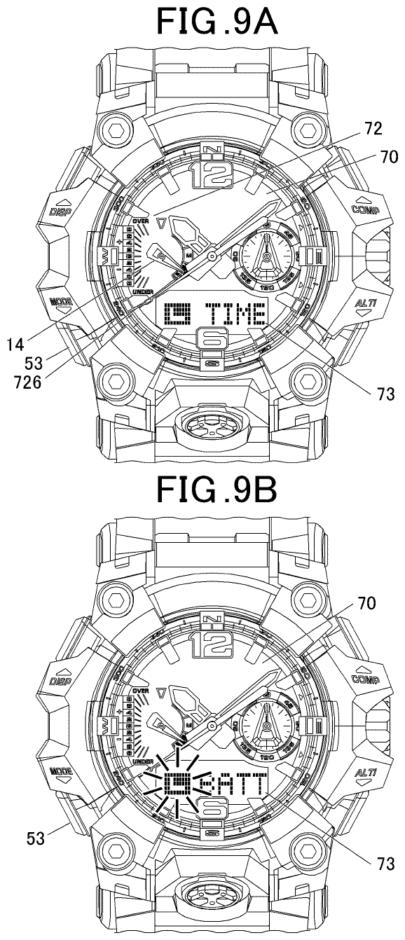

FIG. 9A shows an example of indication by the electronic timepiece 1 within a predetermined period immediately after returning to the BT mode when the remaining battery is “Low”.

As shown in FIG. 9A, immediately after the return to the BT mode, the mode name (TIME) of the BT mode is shown on the right part of the digital indicator 73 for a predetermined period. This allows the user to recognize that the electronic timepiece 1 is back to the BT mode. On the left part of the digital indicator 73, the letter “L” indicating the low remaining battery is shown in a color reverse to the color of the mode name “TIME”. That is, the letter (character) indicating the remaining battery is shown in highlight in a manner different from the other letters (characters) indicating the other information. In the atmospheric pressure indicator 72, the hand 14 is moved to point at the L scale mark 726 of the remaining battery indication area 72c. Thus, the atmospheric pressure indicator 72 indicates that the remaining battery is “Low” for a predetermined period.

After performing the indication in Step T11, the CPU 41 causes the digital indicator 73 to turn on and off the letter “L” as a warning of a battery shortage (Step T12).

In Step T12, the CPU 41 turns on and off the letter “L” and its background shown on the digital indicator 73, as shown in FIG. 9B. The hand 14 in the atmospheric pressure indicator 72 keeps pointing at the L scale mark 726.

Here, the remaining battery determined to be “Low” is a very low battery, and the electronic timepiece 1 will not be able to indicate time soon if left without charging. Therefore, when the remaining battery is determined to be “Low”, the CPU 41 turns on and off the letter “L” and its background on the digital indicator 73 to warn a battery shortage. The CPU 41 keeps the warning without returning to the BT mode until the battery 80 is charged to the battery level of “Middle” or higher by the user.

Next, the CPU 41 obtains the remaining battery (%) of the battery 80 from the remaining battery detector 62 and determines whether the remaining battery is equal to or higher than “Middle” or not (Step T13).

When determining that the remaining battery is not equal to or higher than “Middle” (Step T13: NO), the CPU 41 returns to Step T12.

When determining that the remaining battery is equal to or higher than “Middle” (Step T13: YES), the CPU 41 returns to Step T1.

The CPU 41 repeats the process from Step T1 to Step T13 while the electronic timepiece 1 is operating.

The indication in Steps T3, T6, and T10 can be canceled and shifted to the indication in the next step by the press of the S2 button 52. However, in Step T10 of returning to the BT mode, if the hand 14 returns to the home position 72a before pointing at the correct scale mark corresponding to the remaining battery in the remaining battery indication area 72c in response to the S2 button being pressed, the user may wrongly recognize the remaining battery. To avoid such a circumstance, when the indication of the remaining battery is canceled before the hand 14 points at a correct remaining battery, the CPU 41 rotates the hand 14 to arrive at the correct scale mark corresponding to the remaining battery and then returns the hand 14 to the home position 72a. such a configuration can prevent the user from wrongly recognizing the remaining battery.

The remaining battery is indicated for only a predetermined period (e.g., one second). To avoid the user from overlooking the remaining battery, the electronic timepiece 1 may have a light-emitting diode (LED) for illuminating the dial 70, and the CPU 41 may automatically turn on the LED when indicating the remaining battery (i.e., when returning to the BT mode). For another example, the CPU 41 may judge the brightness around the electronic timepiece 1 in indicating the remaining battery (i.e., in returning to the BT mode) and turn on the LED when the brightness is equal to or lower than a predetermined threshold. The CPU 41 may use a solar battery to judge the brightness. The CPU 41 may have a built-in brightness sensor and judge the brightness based on the detection result of the brightness sensor. Thus, the user can avoid overlooking the indicated remaining battery in a dark place.

The function of automatically turning on the LED in indicating the remaining battery may be activated/deactivated by the pressing of the SA button 55.

The electronic timepiece 1 is configured to return to the BT mode from a mode other than the BT mode when the S3 button 53 is held down for a predetermined period or longer. That is, the electronic timepiece 1 can return to (switch to) the BT mode directly from the atmospheric pressure mode without passing through the stopwatch mode. The hand 14 is rotatable in the regular direction (clockwise direction) and in the counter direction (counterclockwise direction). The rotation in the regular direction is three times faster than the rotation in the counter direction. When switching from the atmospheric pressure mode to the BT mode, the CPU 41 determines in which rotation direction the hand 14 arrives faster at the position of the target scale mark corresponding to the remaining battery in the remaining battery indication area 72c from the current position. Here, the target scale mark is the scale mark that the hand 14 should point at. The CPU 41 then causes the motor 34 to rotate the hand 14 in the determined rotation direction. For example, in a case where the hand 14 is at “−8” of the scale marks 721 and is to be rotated to point at the L scale mark 726 to indicate the remaining battery, the hand 14 arrives at the L scale mark 726 (the central part of the L scale mark 726) faster in the counter rotation. Therefore, the hand 14 is rotated in the counter direction. Thus, the hand 14 can indicate the remaining battery more quickly.

The rotation speed of the counter direction may be faster than the rotation speed of the regular direction. In such a case, when moving the hand 14 from the home position 72a to the remaining battery indication area 72c (e.g., when shifting from the stopwatch mode to the BT mode), the CPU 41 determines in which rotation direction the hand 14 arrives faster at the position of the target scale mark corresponding to the remaining battery in the remaining battery indication area 72c from the current position, as with when shifting from the atmospheric pressure mode to the BT mode. The CPU 41 then rotates the hand 14 in the determined rotation direction.

As described above, the electronic timepiece 1 includes the dial 70, the atmospheric pressure indicator 72 that is provided on a region of the dial 70, and the digital indicator 73 that is provided on a region of the dial 70 different from the region of the atmospheric pressure indicator 72. The CPU 41 causes both the digital indicator 73 and the atmospheric pressure indicator 72, which indicates the remaining battery with the hand 14, to indicate the remaining battery for a predetermined period.

Thus, the electronic timepiece 1 has an increased perceivability of the remaining battery.

For example, the hand 14 is positioned behind the second hand 11, the minute hand 12, and the hour hand 13 that indicate time in the viewing direction. If the remaining battery is indicated only by the hand 14 of the atmospheric pressure indicator 72, and if the hand 14 is overlapped by the second hand 11, the minute hand 12, or the hour hand 13, the user may not visually recognize the remaining battery and may overlook the remaining battery. Since the electronic timepiece 1 indicates the remaining battery on both the digital indicator 73 and the atmospheric pressure indicator 72, the remaining battery is more perceivable.

Further, the CPU 41 causes the digital indicator 73 to indicate a warning of a battery shortage when the remaining battery is less than a threshold. Such a configuration allows the user to recognize the battery shortage.

Further, the hand 14 is rotatable in a regular direction and in a counter direction. When causing the atmospheric pressure indicator 72 to indicate the remaining battery, the CPU 41 causes the hand 14 to rotate in a direction in which the hand 14 arrives faster at the position of the target first scale mark that the hand 14 should point at from the current position of the hand 14. For example, the atmospheric pressure indicator 72 includes (i) the remaining battery indication area 72c having the scale marks for the hand 14 to point at the remaining battery and (ii) the atmospheric pressure indication area 72b having the scale marks 721 for the hand 14 to point at the atmospheric pressure difference (second information different from the remaining battery). The information indicated by the atmospheric pressure indicator 72 can be switched between the remaining battery and the atmospheric pressure difference by the rotation of the hand 14 in the regular direction or in the counter direction. In switching the state of the atmospheric pressure indicator 72 from the state of indicating the atmospheric pressure difference in the atmospheric pressure indicator 72b to the state of indicating the remaining battery in the remaining battery indication area 72c, the CPU 41 rotates the hand 14 in a direction in which the hand 14 arrives faster at the position of the scale mark corresponding to the remaining battery. Thus, the remaining battery is indicated quickly.

Further, the atmospheric pressure indication area 72b is provided outside the remaining battery indication area 72c on the dial 70. Such a configuration can avoid the decrease in the perceivability of the scale marks of the atmospheric pressure difference, which are indicated for a longer time than the remaining battery, by the hour hand 13 or the other hands.

Further, when the S2 button 52 is pressed and receives an instruction to cancel the indication of the remaining battery before the hand 14 points at the target scale mark in the remaining battery indication area 72c, the CPU 41 causes the hand 14 to arrive at the target scale mark and then cancels the indication of the remaining battery. Such a configuration can prevent the user from wrongly recognize the remaining battery.

Further, the CPU 41 causes digital indicator 73 and the atmospheric pressure indicator 72 to indicate the remaining battery at the timing of returning to the BT mode. Thus, the electronic timepiece 1 can indicate the remaining battery at timings of not disturbing the user.

Further, the CPU 41 does not cause the atmospheric pressure indicator 72 to indicate the remaining battery when switching to an operation mode different from the BT mode. Thus, the electronic timepiece 1 can avoid a circumstance in which the function of the operation mode to which the electronic timepiece 1 has switched is unavailable owing to the indication of the remaining battery.

Further, when switching to the BT mode from an operation mode different from the BT mode, the CPU 41 causes the atmospheric pressure indicator 72 to indicate the mode name of the BT mode, to which the electronic timepiece 1 has switched, and the remaining battery for a predetermined period. According to such a configuration, the electronic timepiece 1 does not have to show the mode name and the remaining battery separately (at different timings).

Further, the CPU 41 causes the digital indicator 73 to highlight the remaining battery such that the remaining battery is indicated in a manner different from the mode name. According to such a configuration, the remaining battery is easily perceivable, and the electronic timepiece 1 can reduce the possibility that the user overlook the remaining battery.

The embodiment described above is a preferred example of the electronic timepiece 1 according to the present disclosure and does not limit the present disclosure.

For example, in the above embodiment, the remaining battery is indicated on both of the atmospheric pressure indicator 72 (indicator) and the digital indicator 73 (second indicator) to enhance the viewability of the remaining battery. However, the specific information (first information) to be indicated on both of the first indicator and the second indicator is not limited to the remaining battery.

In the above embodiment, the atmospheric pressure is the second information that is different from the remaining battery and that is indicated on the atmospheric pressure indicator 72 (first indicator). However, the second information is not limited to the atmospheric pressure. For example, the second information may be altitude, temperature, humidity, the world time, or other information.

The shift order of the operation modes and the types of the operation modes described in the above embodiment are examples and do not limit the present disclosure.

The detailed configuration and the detailed operation of the electronic timepiece 1 can be suitably modified without departing from the scope of the present invention.

Although the embodiment of the present invention has been described above, the technical scope of the invention is not limited to the embodiment described above. The technical scope of the invention is defined based on the scope of the claims. Furthermore, the technical scope of the invention includes equivalents in which modifications that are not related to the essence of the invention are added to the scope of the claims.

1. An electronic timepiece comprising:
a dial;
a first indicator provided on a region of the dial;
a second indicator provided on a region of the dial different from the region of the first indicator; and
a processor that causes the first indicator and the second indicator to indicate first information at a predetermined timing for a predetermined period.

2. The electronic timepiece according to claim 1,
wherein the first indicator includes first scale marks and a first pointer for pointing at a first scale mark among the first scale marks, and the first pointer is rotated to point at a target first scale mark among the first scale marks to indicate the first information,
wherein the second indicator digitally indicates the first information.

3. The electronic timepiece according to claim 2,
wherein the dial includes indexes and a second pointer for pointing at an index among the indexes,
wherein the first pointer is positioned behind the second pointer in a direction in which the electronic timepiece is viewed.

4. The electronic timepiece according to claim 1,
wherein the first information is a remaining battery,
wherein, in a situation that the remaining battery is less than a threshold, the processor causes the second indicator to indicate a warning of a remaining battery shortage.

5. The electronic timepiece according to claim 2,
wherein the first pointer is rotatable in a regular direction and in a counter direction,
wherein, in a situation that the processor causes the first indicator to indicate the first information at the predetermined timing, the processor causes the first pointer to rotate in a direction in which the first pointer arrives faster at a position of the target first scale mark from a current position of the first pointer.

6. The electronic timepiece according to claim 5,
wherein the first indicator includes a first area that has the first scale marks and a second area that has a second scale mark for indicating second information different from the first information,
wherein, in a situation that the first indicator is indicating the second information by the first pointer pointing at the second scale mark in the second area and that the processor causes the first indicator to indicate the first information by moving the first pointer from the second area to the first area, the processor causes the first pointer to rotate in a direction in which the first pointer arrives faster at the position of the target first scale mark from the current position of the first pointer.

7. The electronic timepiece according to claim 2,
wherein the first indicator includes a first area that has the first scale marks and a second area that has a second scale mark for indicating second information different from the first information,
wherein the second area is provided outside the first area on the dial.

8. The electronic timepiece according to claim 2, further comprising an operation receiver,
wherein, in a situation that the operation receiver receives an instruction to cancel indication of the first information before the first pointer points at the target first scale mark, the processor causes the first pointer to arrive at the target first scale mark and then cancels the indication of the first information.

9. The electronic timepiece according to claim 1,
wherein the electronic timepiece has multiple operation modes including a first operation mode,
wherein the predetermined timing is a timing of switching to the first operation mode from an other operation mode different from the first operation mode.

10. The electronic timepiece according to claim 9,
wherein the processor does not cause the first indicator to indicate the first information at a timing of switching to the other operation mode.

11. The electronic timepiece according to claim 9,
wherein, at the timing of switching to the first operation mode from the other operation mode, the processor causes the second indicator to indicate a mode name of the first operation mode and the first information for the predetermined period.

12. The electronic timepiece according to claim 11,
wherein the processor causes the second indicator to highlight the first information such that the first information is indicated in a manner different from the mode name of the first operation mode.

13. An indication method for an electronic timepiece that includes a dial, a first indicator provided on a region of the dial, a second indicator provided on a region of the dial different from the region of the first indicator, and a processor, the method being executed by the processor, the method comprising:
causing, by the processor, the first indicator and the second indicator to indicate first information at a predetermined timing for a predetermined period.

14. The method according to claim 13,
wherein the first indicator includes first scale marks and a first pointer for pointing at a first scale mark among the first scale marks, and the first pointer is rotated to point at a target first scale mark among the first scale marks to indicate the first information,
wherein the second indicator digitally indicates the first information.

15. The method according to claim 14,
wherein the electronic timepiece further includes an operation receiver,
wherein, in a situation that the operation receiver receives an instruction to cancel indication of the first information before the first pointer points at the target first scale mark, the processor causes the first pointer to arrive at the target first scale mark and then cancels the indication of the first information.

16. The method according to claim 13,
wherein the electronic timepiece has multiple operation modes including a first operation mode,
wherein the predetermined timing is a timing of switching to the first operation mode from an other operation mode different from the first operation mode,
wherein, at the timing of switching to the first operation mode from the other operation mode, the processor causes the second indicator to indicate a mode name of the first operation mode and the first information for the predetermined period.

17. A non-transitory computer-readable storage medium storing a program that is executable by a processor of a computer of an electronic timepiece, the electronic timepiece including a dial, a first indicator provided on a region of the dial, and a second indicator provided on a region of the dial different from the region of the first indicator,
wherein, in accordance with the program, the processor causes the first indicator and the second indicator to indicate first information at a predetermined timing for a predetermined period.

18. The storage medium according to claim 17,
wherein the first indicator includes first scale marks and a first pointer for pointing at a first scale mark among the first scale marks, and the first pointer is rotated to point at a target first scale mark among the first scale marks to indicate the first information,
wherein the second indicator digitally indicates the first information.

19. The storage medium according to claim 18,
wherein the electronic timepiece further includes an operation receiver,
wherein, in a situation that the operation receiver receives an instruction to cancel indication of the first information before the first pointer points at the target first scale mark, the processor causes the first pointer to arrive at the target first scale mark and then cancels the indication of the first information.

20. The storage medium according to claim 17,
wherein the electronic timepiece has multiple operation modes including a first operation mode,
wherein the predetermined timing is a timing of switching to the first operation mode from an other operation mode different from the first operation mode,
wherein, at the timing of switching to the first operation mode from the other operation mode, the processor causes the second indicator to indicate a mode name of the first operation mode and the first information for the predetermined period.
